(19) United States
(12) Patent Application Publication
(10) Pub. No.: US 2017/0276166 A1
(43) Pub. Date: Sep. 28, 2017

(54) BACKING NUTS HOLDER

(71) Applicant: Donald L Gunnin, Heflin, AL (US)

(72) Inventor: Donald L Gunnin, Heflin, AL (US)

(21) Appl. No.: 15/077,882

(22) Filed: Mar. 22, 2016

(51) Int. Cl. F16B 41/00; F16B 35/00; F16B 43/00

(52) U.S. Cl. CPC F16B 41/002; F16B 43/00; F16B 35/00

(57) ABSTRACT

A device for holding and securing backing nuts for tools, such as disk grinders. The device includes a threaded screw that can be inserted into a threaded connector on the tool. Further, the device includes a threaded receiver that can accept one or more threaded backing nuts. The backing nuts are screwed onto the threaded receiver and thus, attached to the tool such that the backing nuts will not be lost, misplaced or stolen.

### BACKGROUND

The origins of the term “gone nuts” is not clear but, everyone knows that it means to go crazy or to act irrationally. And although the term most likely did not sprout its roots from the following example, it may cause one to pause and think. In some power tools, typically the kind that include a rotating disk, such as a disk grinder, a disk sander and a circular saw, a special nut is used to attach the disks to the power tools. These nuts are traditionally referred to as keepers and backing nuts. A problem arises on the work site with some of these tools as some attachments require the use of the backing nuts and some do not. And so, what often happens is a worker will remove the backing nuts, set them down, install an attachment that does not require backing nuts, and then proceed to use the tool. Sometimes minutes or hours later, the worker may wonder where he placed the backing nuts. In some cases another worker may come by and remove the backing nuts thinking that they were his or hers, or simply taking them for extra. But, once the backing nuts are gone, the tool is crippled and cannot be used with certain attachments until the backing nuts are found or replaced. Such situations have resulted in much frustration in the work place, and in some instances have even resulted in violence. And hence, one may wonder if the saying, “gone nuts” may have originated in relationship to this situation.

What is needed in the art is a solution to provide a secure and reliable device for storing backing nuts when they are not in use.

### BRIEF SUMMARY

The present disclosure presents various embodiments, as well as various features, aspects, advantages and variations that may be selectively incorporated into the various embodiments of a device for holding attachment or removable fasteners used for various tools. One embodiment includes a device for holding and securing backing nuts for tools, such as disk grinders. The device includes a threaded screw that can be inserted into a threaded connector on the tool. Further, the device includes a threaded receiver that can accept one or more threaded backing nuts. The backing nuts are screwed onto the threaded receiver and thus, attached to the tool such that the backing nuts will not be lost, misplaced or stolen.

More specifically, the various embodiments are generally directed towards an apparatus that can be secured to, or built into a tool, or a system, that operates to securely hold and retain removable attachment elements. One embodiment of the apparatus is a removable attachment receiver that can be screwed into the handle receptor of a disk grinder. Such an embodiment includes a receiver that is configured to receive one or more attachment elements of a tool and store the attachment elements. Further, the apparatus includes a connecting interface for attaching the apparatus to the tool. Advantageously, this and other embodiments enable one or more attachment elements to be stored on the apparatus to prevent loss and provide access to the attachment elements. In some embodiments, the receiver, so named as it receives the attachment elements, is threaded and is configured to receive one or more threaded attachment elements.

In various embodiments, the apparatus can be attached to, connected to, affixed to, removeably attached to manufactured in, incorporated in and embedded within a tool, as non-limiting examples. In one such embodiment, the apparatus includes a connecting element that is a threaded screw that can be inserted into the tool. For instance, the tool may have a threaded recess and the apparatus can be screwed into the tool. Further, in some embodiments, the tool includes multiple threaded recesses typically used for the attachment of a handle for controlling to tool. When one of the recesses is not in use, which is typical, the apparatus can be attached to that recess. Typically such tools will include multiple recesses so that the handle can be left hand or right hand mounted. In other embodiments, the apparatus may simply include a connecting rod that can be slid into a recess or aperture of the tool and held in place by a pin, a bring loaded protrusion, a spring loaded ball bearing, or the like as non-limiting examples.

Typically, tools that include removable disks, such as disk grinders, circular saws, etc., include nuts or backing nuts, also referred to as keepers, to hold the disks on to the tool during operation. Generally, the tool includes an axel that rotates and the disk is placed concentric to the axel or spindle and then attached with the backing nut. However, some disks or attachments do not require a backing nut and thus, when installed the backing nut needs to be stored. Thus, the backing nuts can be removed from the axel or spindle and then placed on the receiver of the apparatus.

These embodiments, features, aspects, advantages and variations can take on a variety of forms and further details are presented in the detailed description that follows.

### BRIEF DESCRIPTION OF THE SEVERAL VIEWS OF THE DRAWING

FIG. 1 is a side elevation diagram of an exemplary embodiment of an attachment element holder.

FIG. 2 is a top plan view of an attachment element that can be held by embodiments of the attachment element holder.

FIG. 3 is top plan view of an exemplary embodiment of an attachment element holder.

FIG. 4 is a side elevation view of an exemplary embodiment of an attachment element holder with two attachments and a washer installed.

FIG. 5 is a conceptual diagram of a tool ready to receive an embodiment of an attachment element holder.

FIG. 6 is a conceptual diagram of a tool with an installed attachment element holder.

FIG. 7A is a diagram of a disk grinder illustrating a spindle for receiving a backing nut.

FIG. 7B is a side view of a spindle on a disk grinder.

FIG. 8 is a side view of another embodiment of the attachment element holder.

### DETAILED DESCRIPTION OF EMBODIMENTS

The present disclosure, as well as features and aspects thereof, is directed towards providing a technique to hold and store removable items for a tool to alleviate the risk of losing the items, such as attachment nuts. More specifically, an exemplary embodiment is directed towards an apparatus that can be screwed into a vacant handle receptor of a disk grinder. The apparatus includes a threaded receptor that is the same size as the spindle that receives the backing nuts. Thus, the apparatus is screwed into the disk grinder and is then used to receive and hold/store the backing nuts when they are not in use.

Turning now to the figures, in which like labels represent like elements throughout the several views, various embodiments, as well as various features, aspects, advantages and variations that may be selectively incorporated into the various embodiments are presented in greater detail.

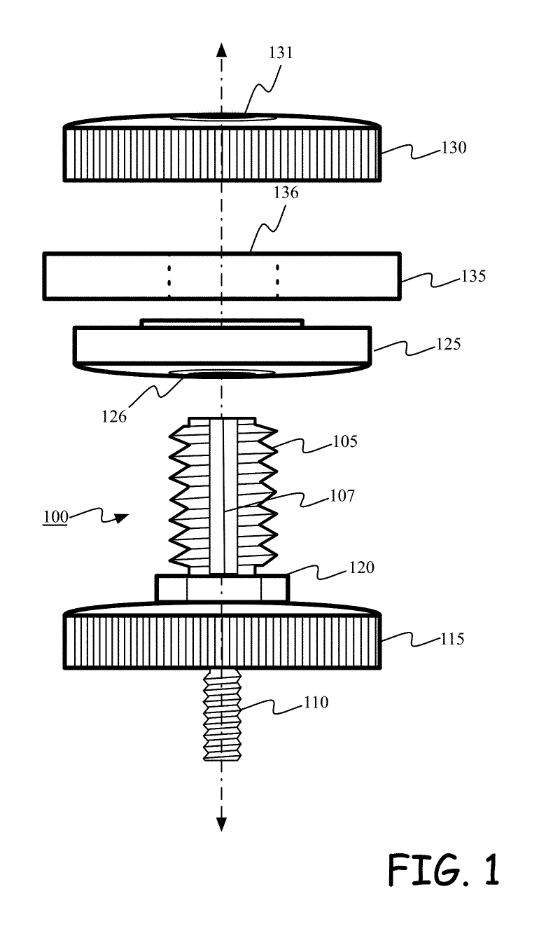

FIG. 1 is a side elevation diagram of an exemplary embodiment of an attachment element holder. Throughout the description, the apparatus will be referred to as the holder. In the illustration, an exemplary holder 100 is shown as including an attachment receiver 105, a connecting interface 110, a friction knob 115 to tighten the holder to a tool by hand and a nut 120 to tighten the holder to a tool with a wrench. In the illustrated embodiment, the attachment receiver 105 is threaded. In an exemplary embodiment used in conjunction with a disk grinder, the attachment receiver 105 is the same diameter and thread count as the spindle. The attachment receiver 105 is configured to receive backing nuts 125 and 130. In typical embodiments, the backing nuts 125 and 130 include an aperture, 126 and 131 respectively, through the center of the nut that is threaded with the same thread count as the attachment receiver 105. In some embodiments, as illustrated, the attachment receiver 105 may include one or more notches 107 that can be used for locking nuts. The notch may be v-shaped, u-shaped, squared or any of a variety of shapes and depths.

The illustration also depicts a washer or spacer 135 that can be positioned between the attachment elements or backing nuts 125 and 130. The washer helps to prevent the backing nuts 125 and 130 from vibrating and becoming loose. The washer 135 can be fabricated from metal, plastic, and silicone as non-limiting examples. The washer 135 includes an aperture 136 passing through the center of the washer. The aperture 136 could be threaded compatibly with the receiver 105 but may also be sized to simply slide over the receiver 105.

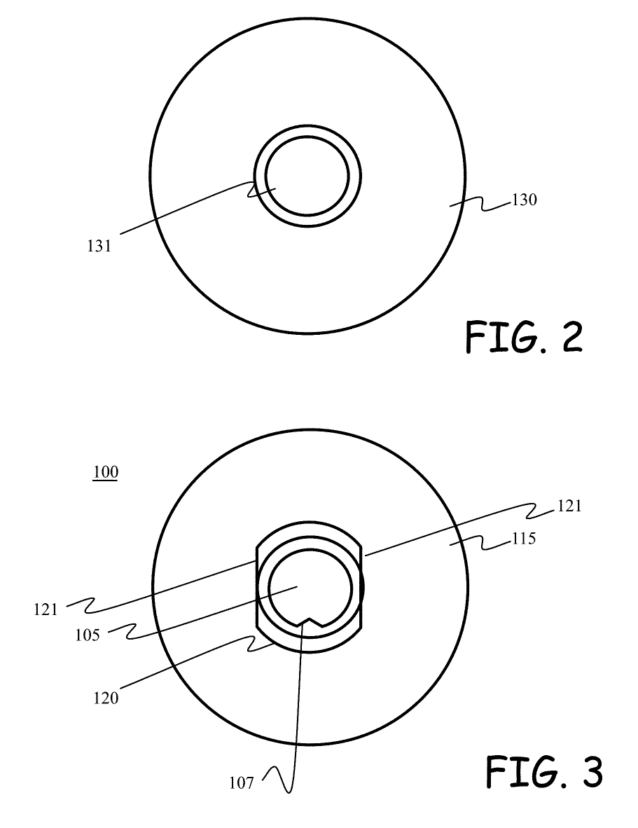

FIG. 2 is a top plan view of an attachment element that can be held by embodiments of the attachment element holder. The illustrated attachment element 130 is a backing nut with a threaded aperture 131.

FIG. 3 is top plan view of an exemplary embodiment of an attachment element holder. The friction knob 115 is illustrated from a top plan view and the top of the receiver 105 can be viewed in the center of the friction knob 115. In addition, nut 120 illustrated as being concentric with the friction knob 115 and the receiver 105. The nut 120 includes at least two opposing flat edges 121 that can be used to receive a wrench or pliers for tightening the holder to a tool.

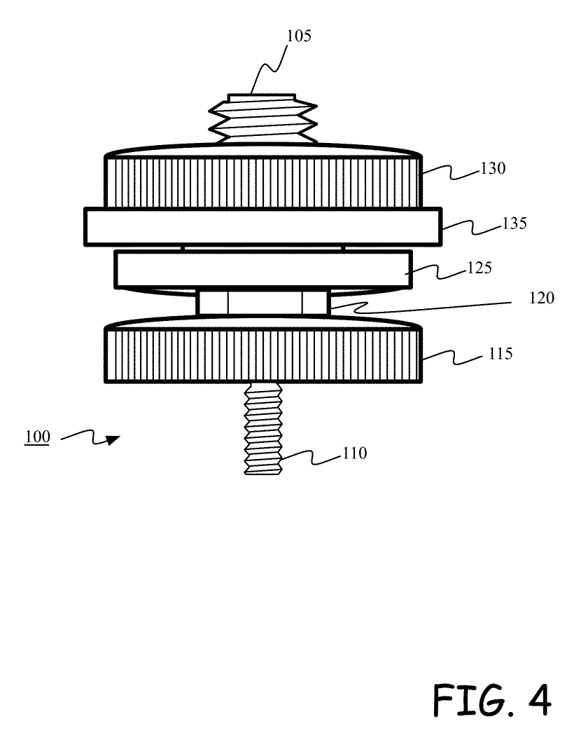

FIG. 4 is a side elevation view of an exemplary embodiment of an attachment element holder with two attachments and a washer installed. As illustrated, the receiver 105 has received two backing nuts 125 and 130 with a washer 135 positioned there between. The holder 100 is illustrated as being free standing but it will be appreciated that typically the holder 100 would be installed on or connected to a tool.

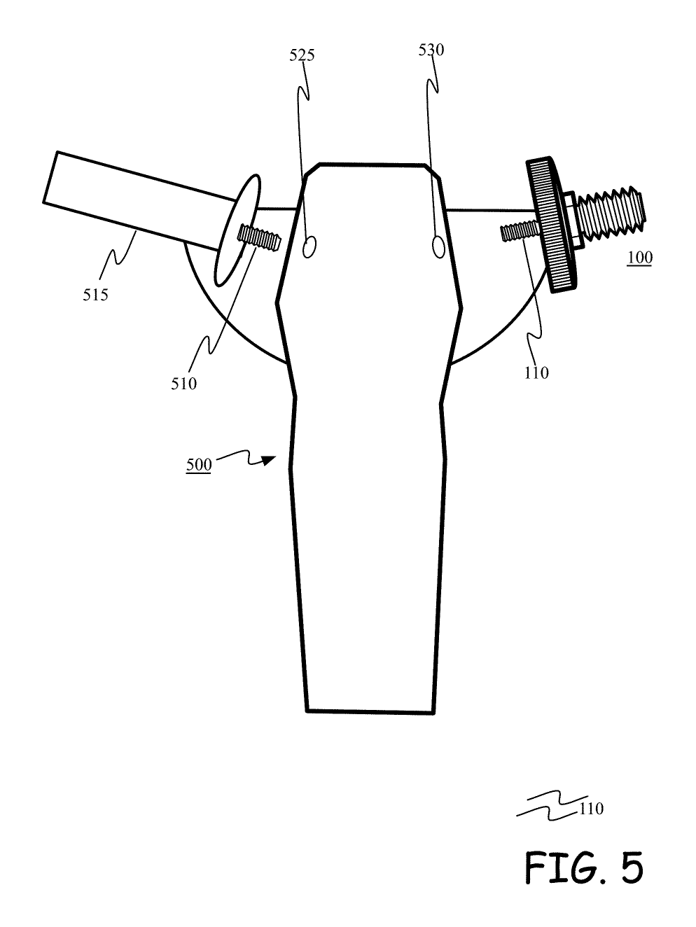

FIG. 5 is a conceptual diagram of a tool ready to receive an embodiment of an attachment element holder. The tool 500, which in the illustrated embodiment generally represents a disk grinder as a non-limiting example, is illustrated as including two threaded female receptors 525 and 530. The illustration presents a handle 515 that includes a male threaded screw 510 that can be screwed into either of the threaded female receptors 525 or 530. In the illustrated embodiment, the handle 515 is illustrated as being poised for being attached to the tool 500 at receptor 525. Further, the holder 100 is illustrated as being poised for being attached to the holder interface 530 of the tool 500.

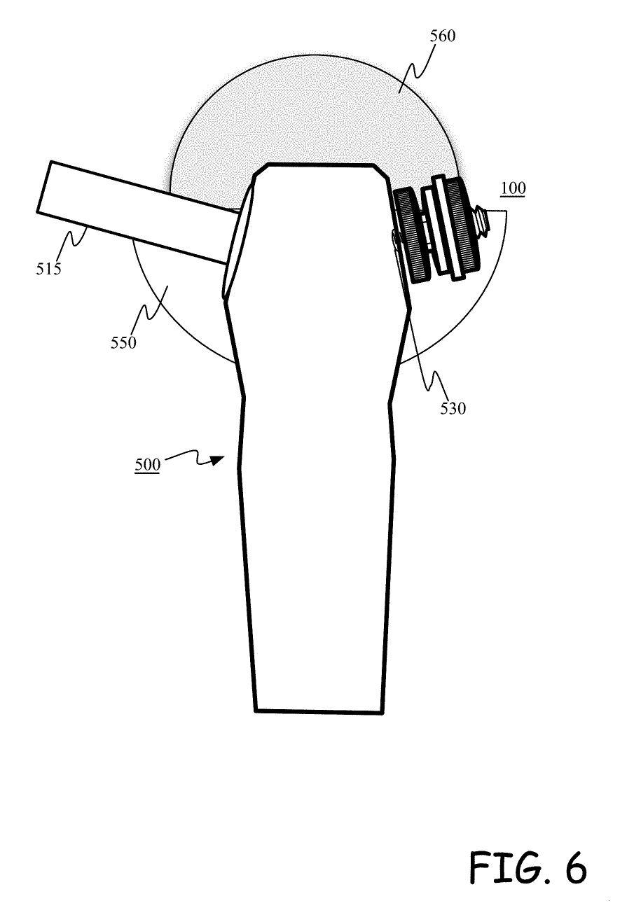

FIG. 6 is a conceptual diagram of a tool with an installed attachment element holder. In the illustrated embodiment, the handle 515 has been screwed into the tool and the holder 100 has been screwed into the other vacant female receptor 530. The tool 500 is further illustrated as including a guard 550 and a disk element 560. It will be appreciated that while embodiments are predominately described as being utilized with a disk grinder, the holder is applicable for any of a variety of tools that include one or more locking or attachment nuts, including, but not limited to 4.5″, 6″, 7″ and 9″ disk grinders, circular saws, table saws, rip saws, sanders, floor polishers, etc.

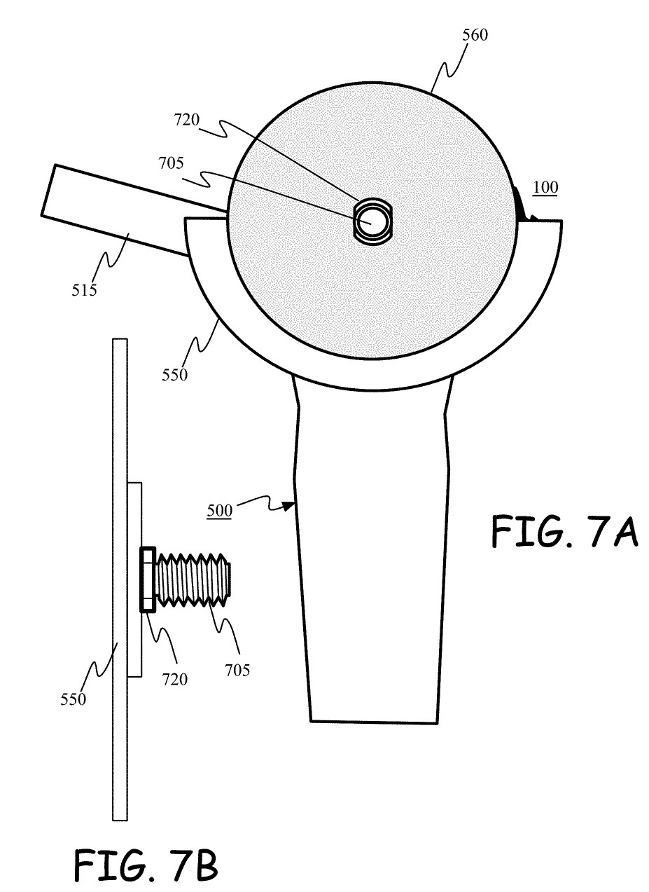

FIG. 7A is a diagram of a disk grinder illustrating a spindle for receiving a backing nut. The disk grinder 500 with handle 515, guard 550 includes a spindle 705. A disk 560 can be placed over the spindle 705 by aligning the central hole of the disk (not illustrated) with the spindle 705 and sliding down the spindle 705 until the lock nut 720 extends through the hole of the disk to secure the orientation of the disk 560. At this point a backing nut can be placed over the disk 560 to secure it in position. The holder 100 is only partially visible.

FIG. 7B is a side view of a spindle on a disk grinder. In this illustrated embodiment, the spindle 705 is shown as extending from the disk grinder 500.

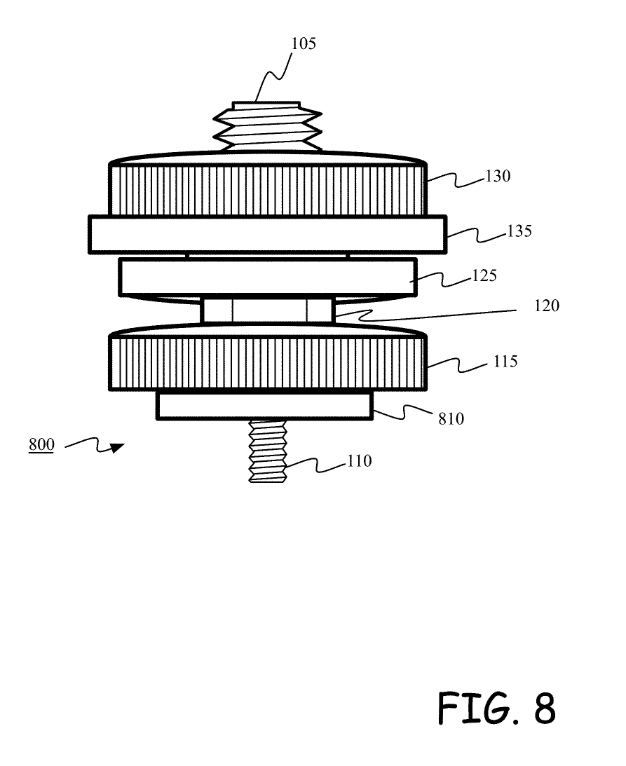

FIG. 8 is a side view of another embodiment of the attachment element holder. In this embodiment, the attachment element holder 800 is shown as further including an offset element 810 that provides a stop-gap between the a friction knob 115 and the body or casing of the tool, such as a disk grinder. The offset element could simply be one or more washers, a threaded spacer, a rubber grommet that slides over the threaded connecting interface 110 or screws onto the same, as well as a structure that is molded into the attachment element holder 800. Advantageously, this element can allow the attachment element holder 800 to be more compatible or suitable for various power tool configurations and can also aid in the removal of the attachment element holder from the tool.

Various embodiments may be utilized to achieve the same spirit and scope of the present invention. In one embodiment, the holder can be fabricated from metal parts by welding a spindle together with a handle screw and a backing nut. Thus, the holder can be fabricated by using spare parts or discarded parts of an old disk grinder. In other embodiments, the holder can be machined, tooled or cast. The materials utilized can vary including various metals having various degrees of hardness such as stainless steel or aluminum, plastics such as nylon, PVC, Teflon or a variety of other hard plastics. Other materials of manufacture are also anticipated.

In the illustrated embodiments, the holder includes a screw that is threaded into a female receiver on the tool. As illustrated, tools may come with several such female receivers in order to accommodate moving a handle to one of several positions. As such, the unused female receivers are ideally suited for installing a holder. However, in some embodiments, space female receivers may not be available. As such, the holder can be attached in a variety of other ways including adhesive, being screwed into the casing of the tool or even built into the tool. Similarly, rather than attaching the holder to the body of the tool, the handle maybe configured to receive the holder. The handle may include a female receiver or other mechanism for receiving the holder. Further, the holder may be attached to the power cord and left dangling.

In addition, rather than a threaded screw, the holder may include a rod with an indention at the distal end. The rod can be slid into a female receiver that includes a spring-loaded lock. As such, the rod can be forced into the female receiver and pressure applied to move the rod past the spring-loaded lock such that the lock is secured within the indention of the rod and thereby holding it securely in place.

In some embodiments, rather than the attachment receiver being threaded, the receiver may simply be a rod that is sized such that the backing nuts can be slid over the rod. The backing nuts can then be secured onto the rod in any of a variety of manners including lock pins, rubber caps, etc.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow..

What is claimed is:

1. An apparatus for holding attachment elements for a tool, the apparatus comprising:
a receiver that is configured to receive one or more attachment elements of a tool and store the attachment elements;
a connecting interface for attaching the apparatus to the tool,
wherein the one or more attachment elements can be stored on the apparatus to prevent loss and provide access to the attachment elements.

2. The apparatus of claim 1, wherein the receiver is threaded and is configured to receive one or more threaded attachment elements.

3. The apparatus of claim 1, wherein the connecting element is a threaded screw that can be inserted into the tool.

4. The apparatus of claim 1, wherein the connecting element is a slide in rod that can be inserted into a receptor located on the tool.

5. The apparatus of claim 1, wherein the one or more attachment elements comprise backing nuts for a tool and the receiver is the same size as a mechanism used on the tool for receiving the backing nuts.

6. The apparatus of claim 1, wherein the connecting interface is threaded and attaches to a threaded receiver embedded in the tool.

7. The apparatus of claim 6, wherein the threaded receiver is one of a plurality of threaded receivers configured to receive a handle used in the operation of the tool.

8. The apparatus of claim 7, further comprising a textured grip for tightening the apparatus into the threaded receiver.

9. The apparatus of claim 7, further comprising a flattened bolt configured to tighten the apparatus into the threaded receiver.

10. The apparatus of claim 1, wherein the receiver is threaded and is configured to receive one or more threaded attachment elements and further comprising a washer that can be placed between attachment elements on the receiver.

11. A system for holding attachment elements for a tool, the system comprising:
a holding apparatus comprising:
a receiver that is configured to receive one or more attachment elements of a tool and store the attachment elements; and
a connecting interface for attaching the apparatus to the tool; and
a tool comprising:
a holder interface for receiving the holding apparatus,
wherein the one or more attachment elements can be stored on the holding apparatus to prevent loss and provide access to the attachment elements.

12. The system of claim 11, wherein the receiver is threaded and is configured to receive one or more threaded attachment elements.

13. The system of claim 11, wherein the connecting element is threaded and can be inserted into the holder interface of the tool.

14. The system of claim 11, wherein the connecting element is a slide in rod that can be inserted into the holder interface located on the tool.

15. The system of claim 11, wherein the one or more attachment elements comprise backing nuts for the tool and the receiver is the same size as a mechanism used on the tool for receiving the backing nuts.

16. The system of claim 11, wherein the connecting interface and the holder interface are compatibly threaded.

17. The system of claim 16, wherein the threaded holder interface is one of a plurality of threaded holder interfaces configured to receive a handle used in the operation of the tool.

18. The system of claim 17, further comprising a textured grip for tightening the apparatus into the threaded holder interface.

19. The system of claim 17, further comprising a flattened bolt configured to tighten the apparatus into the threaded holder interface.

20. The apparatus of claim 11, wherein the receiver is threaded and is configured to receive one or more threaded attachment elements and further comprising a washer that can be placed between attachment elements on the receiver.
